(19) United States
(12) Patent Application Publication
(10) Pub. No.: US 2002/0096585 A1
(43) Pub. Date: Jul. 25, 2002

(54) Kitchen appliance having a processing container and having a container for processing tools

(76) Inventor: Johann Unteregger, Brueckl (AT)

Correspondence Address: U.S Philips Corporation, 580 White Plains Road, Tarrytown, NY, 10591, US

(21) Appl. No.: 09/968,551

(22) Filed: Oct. 3, 2001

(30) Foreign Application Priority Data
Oct. 5, 2000 (EP) 00890302.3

(51) Int. Cl. A47J 43/046

(52) U.S. Cl. 241/282.1

(57) ABSTRACT

In a kitchen appliance (1) having a housing (3) and having a pot-shaped processing container (13) which can be placed onto a housing wall (9) of the housing (3) a pot-shaped storage container (28) has been provided for the storage of processing tools (39, 40, 41, 42, 43, 44, 45, 46, 47, 48) of the kitchen appliance (1), which storage container is of such a design that it can store the processing tools and can be placed into the processing container (13) together with the stored processing tools.

The invention relates to a kitchen appliance having a pot-shaped processing container and having storage means for the storage of processing tools, which storage means can be placed into the processing container when the kitchen appliance is not in operation.

Such a kitchen appliance is known from the patent document WO 98/11810 A1. In the known kitchen appliance the storage means basically comprise a disc-shaped support having recesses and passages and projections, which enables processing tools to be inserted into and placed onto the support, in order to achieve that the processing tools are stored and kept in a well-ordered manner. In practice, it appears that it is often found to be time-consuming and inconvenient of each of the processing tools should first be inserted into the support or placed onto the support in an exactly given position before the support together with the processing tools attached to it can be placed into the processing container.

It is an object of the invention to preclude the aforementioned problems and to realize an improved kitchen appliance.

In order to achieve the object described hereinbefore some characteristic features in accordance with the invention are provided in an apparatus in accordance with the invention, in such a manner that such a kitchen appliance can be characterized in the manner defined hereinafter, namely:

A kitchen appliance having a housing with a housing wall, and having a pot-shaped processing container which can be placed onto the housing wall and in which a plurality of processing tools can be placed, so as to enable foodstuffs to be processed during operation of the kitchen appliance, and having storage means which serve to store the processing tools and which can be placed into the processing container when the kitchen appliance is not in operation, in which the storage means are formed by a likewise pot-shaped storage container, and in which the storage container is of such a design that it can be placed into the processing container.

With a kitchen appliance in accordance with the invention it is achieved in a constructionally very simple manner that the processing tools of the kitchen appliance can be placed in the pot-shaped storage container in a more or less arbitrary manner and the storage container can subsequently be placed into the processing container, as a result of which a space-saving storage for the processing tools is achieved but without an accurate positioning of the processing tools being required.

With a kitchen appliance in accordance with the invention the storage container may be designed and dimensioned in such a manner that the storage container can be accommodated wholly inside the holding space formed by the processing container and by a cover for closing the processing container. However, the holding volume of the storage container is thus limited by the volume of this holding space. Therefore, it has proved to be very advantageous when a kitchen appliance in accordance with the invention in addition has the characteristic features as defined in claim 2. Thus, it is achieved that the storage container can be almost arbitrarily high and that the cover, which has been provided anyway for closing the processing container, is utilized for closing the storage container.

It has proved to be particularly advantageous when the cover can be connected both to the processing container and to the storage container with the aid of a bayonet coupling because this is a particularly simple construction.

Furthermore, it has proved to be very advantageous when it is also possible to form a bayonet coupling between the processing container and the storage container because this guarantees a reliable connection of these two containers.

The aforementioned aspects as well as further aspects of the invention will be apparent from the example of an embodiment described hereinafter and will be elucidated with the aid of this example.

The invention will be described in more detail hereinafter with reference to an embodiment which is shown in the drawings by way of example but to which the invention is not limited.

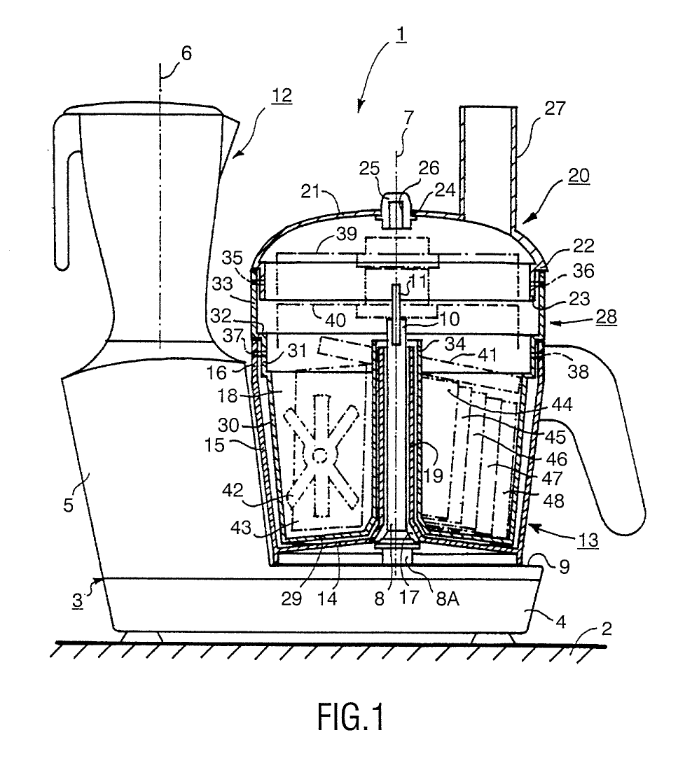

FIG. 1 is a diagrammatic side view and partly sectional view of a kitchen appliance in accordance with the invention.

FIG. 1 shows a kitchen appliance 1, which has been placed on a worktop. The kitchen appliance 1 has a housing 3, which has a base section 4 and a tower section 5. The turret section 5 accommodates an electric motor (not shown) by means of which two drive arrangements (not shown) can be driven. A first drive shaft (not shown), which is coaxial with a first axis 6, can be driven rotationally by a first drive arrangement accommodated inside the tower section. A second drive shaft 8, which is coaxial with a second axis 7, can be driven rotationally by a second drive arrangement accommodated essentially inside the base section 4. The second drive shaft 8 fits onto a drive mandrel 8A, which forms a part of the second drive arrangement and which extends through a housing wall 9 of the bottom section 4 of the housing 3 and which projects from the housing wall 9. The drive shaft 8 is axially movable with respect to the drive mandrel 8A and is removable from the drive mandrel 8A. The free end 10 of the second drive shaft 8 carries a cylindrical bearing pin 11, which is coaxial with the drive shaft 8.

With the aid of the first drive arrangement, by means of which the first drive shaft, which is coaxial with a first axis 6, can be driven rotationally, a processing tool (not shown) can be driven via the first drive shaft, which tool is situated inside a pitcher-shaped processing container 21 and is rotatably supported.

The kitchen appliance 1 further has a pot-shaped processing container 13, which can be placed onto the housing wall 9. The pot-shaped processing container 13 has a substantially ring-shaped bottom wall 14 and a circumferential wall 15 connected to the bottom wall 14 in the peripheral area of the latter, which circumferential wall 15 has a diameter which increases in a direction away from the bottom wall 14 and which circumferential wall 15 terminates in a hollow cylindrical processing container rim 16 in its area that is remote from the bottom wall 14. In the inner area of the ring-shaped bottom wall 14 of the processing container 13 the ring-shaped bottom wall 14 has a passage 17 which is closed with respect to the inner space 18 of the processing container 13 by a hollow cylindrical closing sleeve 19, through which hollow cylindrical closing sleeve 19 the second drive shaft 8 extends.

To close the pot-shaped processing container 13 during operation of the kitchen appliance 1 the kitchen appliance 1 has a dome-shaped cover 20, which has a curved upper wall 21 which changes into a hollow cylindrical cover rim 23 via a radial transitional portion 22. In the center of the cover 20 the cover 20 has a passage 24 in which a bearing sleeve 25 is fitted and secured. The bearing sleeve 25 has a bore 26 in which the bearing pin 11 engages when the cover 20 is placed on the processing container 13. The cover 20 further has a feed-in tube 27, which projects from the upper wall 21 and through which a substance to be cut or processed can be inserted in order to be cut or processed in the inner space 18 of the processing container 13 during operation of the kitchen appliance 1.

At option, one of a plurality of processing tools can be placed in the processing container 13 and can then be coupled to the second drive shaft 8 and can thus be brought into driving engagement with this shaft. These processing tools are, as is for example also known from the patent document WO 98/11810 A1 already mentioned in the introductory part, a cutter disc having a plurality of exchangeable cutters, a grater disc, stirring tools, mixing tools and similar processing tools. With the aid of each of these processing tools it is possible to process foodstuffs during operation of the kitchen appliance 1.

The kitchen appliance 1 further has storage means for storing the aforementioned processing tools. In a particularly simple and advantageous manner the storage means in the present case are formed by a storage container 28, which is pot-shaped like the processing container 13. The storage container 28 is of such a design that the storage container 28 can be placed into the processing container 13, as a result of which the storage container 28 can be put into the processing container 13 when the kitchen appliance 1 is not in operation.

The storage container 28 has a substantially ring-shaped bottom wall 29 and a circumferential wall 30, which is connected to the bottom wall 29 in the peripheral area of the bottom wall 29 and which terminates in a first hollow cylindrical storage container rim 31, which in its turn changes into a second hollow cylindrical storage container rim 33 via a radial collar 32. The second storage container rim 33 has a larger diameter than the first storage container rim 31. The second storage container rim 33 has essentially the same diameter as the processing container rim 16. When the storage container 28 is disposed in the processing container 13 the storage container 28 is supported with its collar 32 on the free edge portion of the processing container rim 16. In the inner area of the ring-shaped bottom wall 29 of the storage container 28 a closing sleeve 34 projects from the bottom wall 29 and surrounds the closing sleeve 19 of the processing container 13.

When the kitchen appliance 1 is not in operation and the storage container 28 has been placed in the processing container 13 the storage container 28 can be closed by means of the cover 20. When the cover 20 has been placed on the storage container 28 the cover is supported on the free edge portion of the second storage container rim 33 with its transitional portion 22 provided between the upper wall 21 and the cover rim 33.

The cover 20 has two bayonet pins 35 and 36 as first bayonet means, which pins serve to form a bayonet coupling. The two bayonet pins 35 and 36 are fixedly connected to the cover rim 23 and project from the cover rim 23 in radially outward directions. The processing container 13 and the storage container 28 both have similar second bayonet means for cooperation with the first bayonet means of the cover, which first bayonet means are formed by two bayonet pins 35 and 36. For simplicity the second bayonet means are not shown in FIG. 1. The second bayonet means are formed by bayonet slots which are L-shaped, one portion of each bayonet slot extending parallel to the second axis 7 and terminating in the free edge portion of the processing container rim 16 or of the second storage container rim 33 and the other portion extending perpendicularly to the second axis 7.

As regards the bayonet means of the kitchen appliance 1 it is to be noted that the storage container 28 in addition has the same first bayonet means as the cover 20. In other words, the storage container 28 has also two bayonet pins 37 and 38, which in the present case are fixedly connected to the first storage container rim 31 and which project from the first storage container rim 31 in radially outward directions. Thus, it is achieved that when the storage container 28 is disposed in the processing container 13 the first bayonet means of the storage container 28, i.e. the two bayonet pins 37 and 38 of the storage container 28, cooperate with the second bayonet means of the processing container 13 in order to form a bayonet coupling.

When the cover is disposed on the storage container 28 the first bayonet means of the cover 20, i.e. the two bayonet pins 35 and 36 of the container 20, cooperate with the second bayonet means of the storage container 28.

During operation of the kitchen appliance, in which case the storage container 28 has been removed from the processing container 13, the cover 20 is placed directly onto the processing container 13, the first bayonet means of the cover 20, i.e. the two bayonet pins 35 and 36 of the cover 20, then cooperating with the second bayonet means of the processing container 13.

Thus, with the aid of the bayonet means described hereinbefore a reliable coupling between the processing container 13 and the storage container 28 and the cover 20 and between the storage container 28 and the cover 20 is guaranteed in all operating situations.

The processing tools 39, 40, 41, 42, 43, 44, 45, 46, 47 and 48 of the kitchen appliance 1, which for the clarity of the drawing are shown in dash-dot lines in FIG. 1, can be put into the storage container 28 in a substantially arbitrary manner, which has the advantage that the processing tools 39 to 48 need not be arranged in a particular manner, which is in line with an uncomplicated and rapid storage of the processing tools 39 to 48 in the storage container 28. Furthermore, the kitchen appliance 1 has the advantage that the storage function of the storage container 28 is available both when the kitchen appliance 1 is not in operation and storage container 28 is disposed in the processing container 13 and during operation of the kitchen appliance, when the storage container 28 has been removed from the processing container 13.

In an advantageous variant of the kitchen appliance 1 shown in FIG. 1, which variant is not shown, the storage container 28 has additional means with the aid of which the drive shaft 8, which is axially movable with respect to the drive mandrel 8A, is moved in an axial direction away from the housing wall 9, i.e. moved upward, when the processing container 13 is placed onto the housing wall 9 while the storage container 28 is disposed in the processing container 13, as a result of which the driving engagement between the drive mandrel 8A and the drive shaft 8 is interrupted, thereby ensuring that in this situation, in which the processing container 13 together with the storage container 28 placed therein is disposed on the housing wall 9, undesired driving of the drive shaft 8 is precluded.

As regards the drive shaft 8 it is to be noted in addition that instead of the drive shaft 8 it is also possible to provide differently constructed drive means for driving processing tools, as is known since long from a multitude of known kitchen appliances.

1. A kitchen appliance (1)
having a housing (3) with a housing wall (9) and
having a pot-shaped processing container (13) which can be placed onto the housing wall (9) and in which a plurality of processing tools (39, 40, 41, 42, 43, 44, 45, 46, 47, 48) can be placed, so as to enable foodstuffs to be processed during operation of the kitchen appliance, and
having storage means which serve to store the processing tools and which can be placed into the processing container (13) when the kitchen appliance (1) is not in operation,
in which the storage means are formed by a likewise pot-shaped storage container (28), and
in which the storage container (28) is of such a design that it can be placed into the processing container (13).

2. A kitchen appliance (1) as claimed in claim 1,
in which a cover (20) has been provided, for closing the processing container (13) during operation of the kitchen appliance (1), and
in which the storage container (28) can be closed by the cover (20) when the kitchen appliance (1) is not in operation and when the storage container (28) is disposed in the processing container (13).

3. A kitchen appliance (1) as claimed in claim 2,
in which the cover (20) has first bayonet means (35, 36) for forming a bayonet coupling, and
in which both the processing container (13) and the storage container (28) have similar second bayonet means for cooperation with the first bayonet means (35, 36) of the cover (20).

4. A kitchen appliance (1) as claimed in claim 3,
in which the storage container (28) in addition has first bayonet means (37, 38) similar to those of the cover (20), and
in which, when the storage container (28) is disposed in the processing container (13), the first bayonet means (37, 38) of the storage container (28) cooperate with the second bayonet means of the processing container (13) so as to form a bayonet coupling.
